(19) United States
(12) Patent Application Publication
(10) Pub. No.: US 2026/0350369 A1
(43) Pub. Date: Nov. 5, 2026

(54) METHOD, APPARATUS, DEVICE AND STORAGE MEDIUM FOR INFORMATION PROCESSING

(71) Applicant: Beijing Zitiao Network Technology Co., Ltd., Beijing (CN)

(72) Inventors: Lingjie LUO, Beijing (CN); Wencheng ZHANG, Beijing (CN); Shiqin QIAO, Beijing (CN); Qian XU, Beijing (CN); Huichao WANG, Beijing (CN); Meng LI, Beijing (CN); Jindong HONG, Beijing (CN); Yijun HE, Beijing (CN)

(21) Appl. No.: 19/664,727

(22) Filed: Apr. 30, 2026

(30) Foreign Application Priority Data
Apr. 30, 2025 (CN) 202510572926.6

(51) Int. Cl. G06N 3/0475

(52) U.S. Cl. CPC G06N 3/0475

(57) ABSTRACT

Embodiments of the disclosure relate to a method, an apparatus, a device, and a storage medium for information processing. The method proposed here includes: providing video content associated with an object to a first model to generate an action description text of at least one action of the object; and providing the action description text and first information to a second model to generate evaluation content about the object, the first information at least describing action evaluation information associated with an evaluation target, the evaluation content indicating an evaluation result of the object with respect to the evaluation target. In this way, the embodiments of the disclosure improve the accuracy of the output result.

### CROSS-REFERENCE

The present application claims the priority of Chinese Patent Application No. 202510572926.6, filed on Apr. 30, 2025, and entitled “Method, Apparatus, Device and Storage Medium for Information Processing”, which is hereby incorporated by reference in its entirety.

### FIELD

Example embodiments of the present disclosure generally relate to the field of computers, and in particular, to a method, an apparatus, a device, and a computer-readable storage medium for information processing.

### BACKGROUND

With the increasing maturity of computer technologies, more and more users use computer technologies to assist work and learning. Users may parse video content through model technologies and output motion evaluation about an object according to actions of the object in a video. However, the accuracy of motion evaluation output by a traditional machine learning model is poor.

### SUMMARY

In a first aspect of the present disclosure, a method of information processing is provided. The method includes: providing video content associated with an object to a first model to generate an action description text of at least one action of the object; and providing the action description text and first information to a second model to generate evaluation content about the object, the first information at least describing action evaluation information associated with an evaluation target, the evaluation content indicating an evaluation result of the object with respect to the evaluation target.

In a second aspect of the present disclosure, an apparatus for information processing is provided. The apparatus includes: a first generation module configured to provide video content associated with an object to a first model to generate an action description text of at least one action of the object; and a second generation module configured to provide the action description text and first information to a second model to generate evaluation content about the object, the first information at least describing action evaluation information associated with an evaluation target, the evaluation content indicating an evaluation result of the object with respect to the evaluation target.

In a third aspect of the present disclosure, an electronic device is provided. The device includes at least one processor; and at least one memory, the at least one memory being coupled to the at least one processor and storing instructions for execution by the at least one processor, the instructions, when executed by the at least one processor, causing the device to perform the method of the first aspect.

In a fourth aspect of the present disclosure, a computer-readable storage medium is provided. The computer-readable storage medium has a computer program stored thereon, the computer program being executable by a processor to implement the method of the first aspect.

It should be understood that the content described in the content part of the present disclosure is neither intended to limit key features or important features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the embodiments of the present disclosure will become more apparent in combination with the drawings and with reference to the following detailed description. In the drawings, the same or similar reference symbols refer to the same or similar elements, where:

FIG. 1 shows a schematic diagram of an example environment in which the embodiments of the present disclosure may be implemented;

FIG. 2 shows a flowchart of an example process of information processing according to some embodiments of the present disclosure;

FIG. 3 shows a flowchart of an example process of information processing according to some embodiments of the present disclosure;

FIG. 4 shows a schematic diagram of a model for information processing according to some embodiments of the present disclosure;

FIG. 5 shows a schematic structural block diagram of an example apparatus for information processing according to some embodiments of the present disclosure; and

FIG. 6 shows a block diagram of an electronic device capable of implementing a plurality of embodiments of the present disclosure.

### DETAILED DESCRIPTION OF EMBODIMENTS

The embodiments of the present disclosure will be described in more detail below with reference to the drawings. Although some embodiments of the present disclosure are shown in the drawings, it should be understood that the present disclosure may be implemented in various forms and should not be construed as limited to the embodiments set forth herein. On the contrary, these embodiments are provided for a more thorough and complete understanding of the present disclosure. It should be understood that the drawings and embodiments of the present disclosure are only for illustrative purposes, and are not intended to limit the protection scope of the present disclosure.

It should be noted that any section/subsection titles provided in this paper are not restrictive. Various embodiments are described throughout this paper, and any type of embodiment may be included under any section/subsection. In addition, the embodiments described in any section/subsection may be combined in any way with any other embodiments described in the same section/subsection and/or different section/subsection.

In the description of the embodiments of the present disclosure, the term “include/comprise” and similar terms should be understood as open-ended inclusions, that is, “include/comprise but not limited to”. The term “based on” should be understood as “at least partially based on”. The term “an embodiment” or “the embodiment” should be understood as “at least one embodiment”. The term “some embodiments” should be understood as “at least some embodiments”. Other definitions, either explicit or implicit, may also be included below. The terms “first”, “second”, etc. may refer to different or same objects. Other definitions, either explicit or implicit, may also be included below.

The embodiments of the present disclosure may involve data of users, acquisition and/or use of data, etc. These aspects all comply with corresponding laws, regulations and related provisions. In the embodiments of the present disclosure, all collection, acquisition, processing, forwarding, use, etc. of data are carried out on the premise that users are aware of and confirm. Accordingly, when implementing various embodiments of the present disclosure, users should be informed of the type, use scope, use scenarios, etc. of data or information that may be involved and obtain the authorization of users by appropriate means according to relevant laws and regulations. The specific manner of informing and/or authorizing may vary according to the actual situation and application scenarios, and the scope of the present disclosure will not be limited in this regard.

If the solutions in the specification and embodiments involve personal information processing, the processing will only be carried out on the premise that there is a legal basis (for example, the consent of the personal information subject is obtained, or it is necessary to perform a contract, etc.), and the processing will only be carried out within the scope of regulations or agreements. If a user refuses to process personal information other than the necessary information required for the basic functions, it will not affect the user's use of the basic functions.

As mentioned above, users may use a machine learning model to parse video content and output a motion evaluation about an object according to actions of the object in a video. However, the accuracy of the motion evaluation output by a traditional machine learning model is poor.

The embodiments of the present disclosure provide a solution for information processing. According to the solution, video content associated with an object is provided to a first model to generate an action description text of at least one action of the object; and the action description text and first information are provided to a second model to generate evaluation content about the object, the first information at least describing action evaluation information associated with an evaluation target, the evaluation content indicating an evaluation result of the object with respect to the evaluation target.

In this way, in the embodiments of the present disclosure, two models are used to perform action understanding and result evaluation, respectively. First, in the embodiments of the present disclosure, a video is processed by the first model to obtain an action description text of an object in the video. Then, in the embodiments of the present disclosure, the action description text is analyzed by the second model to obtain evaluation content about the object. Compared with the traditional solution of directly analyzing a video using a model, in the solution proposed in the present disclosure, both models may be trained more professionally, thereby improving the robustness of the entire information processing solution and the accuracy of its output result. Furthermore, the second model analyzes the action description text in combination with the first information describing the action evaluation information associated with the evaluation target, so that the evaluation content output by the second model is more in line with the evaluation needs of users, thereby further improving the accuracy of the evaluation content about the object.

Various example implementations of the solution will be described in detail below in further combination with the drawings.

### Example Environment

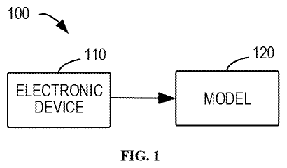

FIG. 1 shows a schematic diagram of an example environment 100 in which the embodiments of the present disclosure may be implemented. As shown in FIG. 1, the example environment 100 may include an electronic device 110. In some embodiments, the electronic device 110 may provide video content associated with an object to a first model to generate an action description text of at least one action of the object; and provide the action description text and first information to a second model to generate evaluation content about the object, the first information at least describing action evaluation information associated with an evaluation target, the evaluation content indicating an evaluation result of the object with respect to the evaluation target.

The model 120 may be deployed on the electronic device 110 or other devices, which will not be described in detail here. The electronic device 110 may output the above evaluation result through the model 120. The model 120 may include a first model and a second model.

In some embodiments, the electronic device 110 may be any type of mobile terminal, fixed terminal or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/video camera, a positioning device, a television receiver, a radio broadcast receiver, an e-book device, a game device, or any combination of the foregoing, including accessories and peripherals of these devices or any combination thereof. In some embodiments, the electronic device 110 may also support any type of interface for a target user (such as a “wearable” circuit, etc.).

The electronic device 110 may also be an independent physical server, a server cluster or a distributed system composed of multiple physical servers, or a cloud server that provides basic cloud computing services such as cloud services, cloud databases, cloud computing, cloud functions, cloud storage, network services, cloud communications, middleware services, domain name services, security services, content delivery networks, and big data and artificial intelligence platforms. The electronic device 110 may include, for example, a computing system/server, such as a mainframe, an edge computing node, a computing device in a cloud environment, and so on.

It should be understood that the structure and function of each element in the environment 100 are described only for the purpose of illustration, without implying any limitation on the scope of the present disclosure.

Some example embodiments of the present disclosure will be described below with continued reference to the drawings.

### Example Process

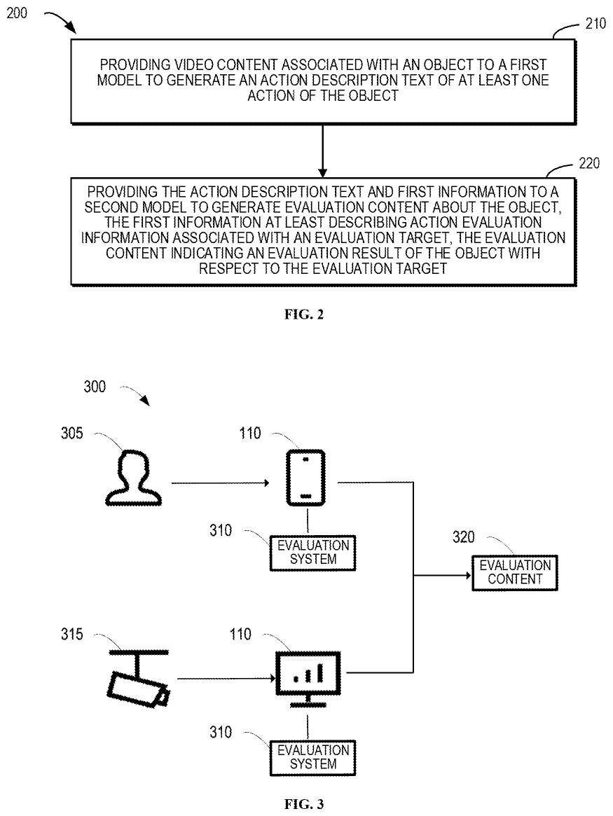

FIG. 2 shows a flowchart of an example process 200 of information processing according to some embodiments of the present disclosure. The process 200 may be implemented at the electronic device 110. The process 200 may be applied to motion evaluation based on video action identification, such as disease diagnosis, scoring of sports events such as gymnastics and dance, etc., which will not be limited here.

As shown in FIG. 2, at a block 210, the electronic device 110 provides video content to a first model to generate an action description text of at least one action of an object.

FIG. 3 shows a flowchart of an example process 300 of information processing according to some embodiments of the present disclosure.

As shown in FIG. 3, in some embodiments, a user 305 may actively capture or upload video content through the electronic device 110. The electronic device 110 processes the video content through an evaluation system 310 deployed thereon to generate evaluation content 320 about the object in the video content.

In other embodiments, the electronic device 110 may also be connected to an external device 315 such as a home camera. On the premise of obtaining user authorization, the electronic device 110 periodically or irregularly obtains video content about the user from the external device 315. Then, the electronic device 110 processes the video content through the evaluation system 310 deployed thereon to generate the evaluation content 320 about the object in the video content.

In some embodiments, the above object may refer to one or more objects in the video content. The video content associated with the object may be a video of the object shot by a non-professional imaging device, where the video shooting device may be a daily shooting device such as a mobile phone or a home video camera. The video content may include content of daily life, work and sports of the object, which will not be limited here. Alternatively, the video content may be uploaded by a storage device storing the video content, such as a computer, a server, etc. Actions may include daily actions such as walking, raising hands, taking and placing items, or preset actions such as holding the head with both hands, raising both arms horizontally, and circling both arms. The action description text may be a text describing the performance of the above actions by the object.

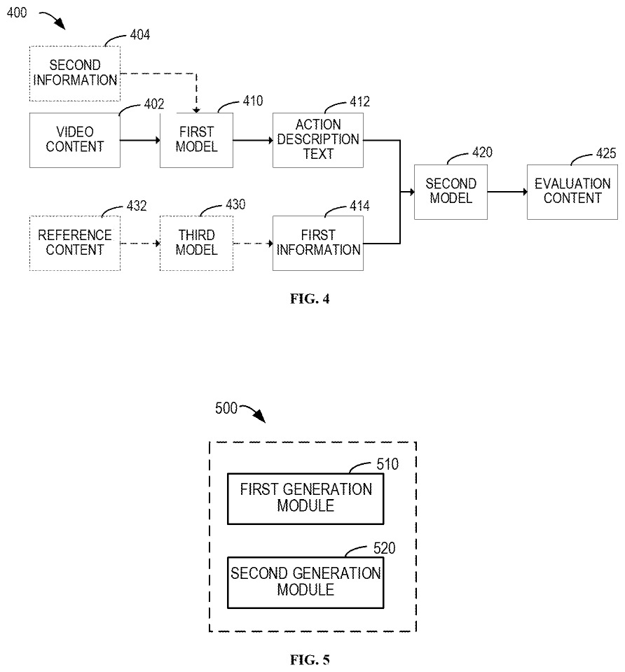

FIG. 4 shows a schematic diagram of a model 400 for information processing according to some embodiments of the present disclosure.

As shown in FIG. 4, in some embodiments, the first model 410 is a multimodal model, that is, a machine learning model that may simultaneously process and understand multiple types of data, such as text, image, audio, video, etc. For example, the first model 410 may be a visual language model.

The first model 410 may receive one or more pieces of video content 402 associated with an object, and perform understanding and analysis on actions of the object in the video content 402 to generate an action description text 412 of the object in the video content 402. As an example, the video content 402 may include content of motions of objects. The first model 410 may generate a corresponding action description text 412, for example, the object raises both hands simultaneously, etc. As an example, the first model 410 may respectively output action description texts 412 corresponding to multiple actions of the object according to the video content 402, for example, action 1: raising both hands, action 2: holding the head with both hands, and so on.

In some embodiments, the electronic device 110 also provides second information 404 to the first model 410, and then the first model 410 may generate the action description text 412 of the object in the video content 402 based on the second information 404 and the video content 402. As an example, the second information 404 may indicate an action identification criterion associated with a set of preset actions.

Taking a scenario of video diagnosis of shoulder joint diseases as an example, the preset actions may be reference actions that may reflect shoulder joint diseases. For example, an abduction action, that is, the arms are lifted horizontally to both sides of the body; for another example, a back-touching action, that is, the object touches the contralateral scapula with one hand from above and touches the back with the other hand from below, etc. Through the second information 404, the first model 410 may more efficiently and accurately identify whether the object in the video has performed the above preset actions.

In some embodiments, the second information 404 may also indicate a set of capabilities associated with the first model 410, through which the first model 410 may generate a more detailed and accurate action description text 412.

In some embodiments, the set of capabilities includes a first capability for identifying an action of the object, which is used to capture the action of the object in the video content 402. The first model 410 may identify, through the first capability, that the object in the video content has performed actions such as action 1, action 2, action 3, and action 4, which may include a preset action.

In some embodiments, the set of capabilities also includes a second capability of describing a trajectory of the corresponding action. As an example, action 1 is raising both arms. The first model 410 may specifically describe the action of raising both arms through the second capability, for example, the left arm is raised to 180° to the left side of the body, and the right arm is raised to 150° to the right side of the body.

In some embodiments, the set of capabilities also includes a third capability of analyzing symmetry of the corresponding action. For example, when the object raises both arms, the left arm is raised to 180° to the left side of the body, and the right arm is raised to 150° to the right side of the body. The first model 410 may perform analysis through the third capability, and obtain that the raising angles of the left and right arms of the object are asymmetric when performing action 1. Accordingly, the action description text 412 may describe that the action has asymmetric raising angles of the left and right arms.

In some embodiments, the set of capabilities also includes a fourth capability of analyzing compensation information of the corresponding action. The first model 410 may obtain, through the fourth capability, whether there is a compensation situation in a process of the object completing the action according to a specification and an actual completion situation of the action. As an example, a specification of the action of raising both arms is to keep a shoulder sinking state of shoulder joints when both arms are raised. If the object raises both arms with a shrugging action, the first model 410 may perform analysis through the fourth capability, and obtain that there is a shoulder joint compensation situation when the object performs action 1. Accordingly, the action description text 412 may describe that the action has shoulder joint compensation.

In some embodiments, the set of capabilities also includes a fifth capability of analyzing fluency of the corresponding action. The first model 410 may obtain the fluency of the object in completing the action through the fifth capability according to the completion situation of the action, such as whether the action is accompanied by trembling or whether there is an obvious stagnation during the action. As an example, the first model 410 may analyze whether the action of the object is fluent. For example, if the action of the object has an obvious stagnation, the action description text 412 may describe that the fluency of the object in performing action 1 is low.

In this way, the first model 410 may use the above capabilities to generate the action description text 412 that better matches the evaluation target. Because the action description itself is relatively broad, for example, for the action of raising both arms, the related description may also include the actions and postures of the elbows, wrists and fingers on both sides when both arms are raised. The first model 410 uses the second information 404 to guide the direction and focus of the action description, to obtain a more precise and effective action description text 412.

In some embodiments, the second information 404 may also be configured to instruct the first model 410 to use relative position description to generate the action description text 412. As an example, in a diagnosis criterion of shoulder joint diseases, because each object has different basic data such as height, weight and arm span, compared with diagnosis based on an activity distance of the arm and other parts, a positional relationship between the arm and parts such as the shoulder, back and head may more accurately determine a range of motion of the shoulder joint. As an example, the action description text 412 generated accordingly may be that the arm touches the contralateral scapula backward, the arm is raised above the head, and so on.

In this way, the second information 404 combines dynamic action description and static posture description to more accurately describe the action of the object in the video content 402, so that the first model 410 may generate the action description text 412 that is more relevant to the evaluation target. In other embodiments, the second information 404 may also be adjusted and set according to different evaluation targets, which will not be limited here.

Continuing to refer to FIG. 2, at a block 220, the electronic device 110 provides the action description text 412 and first information 414 to a second model 420 to generate evaluation content 425 about the object, the first information 414 at least describing action evaluation information associated with an evaluation target, the evaluation content 425 indicating an evaluation result of the object with respect to the evaluation target.

In some embodiments, the evaluation target may be motion evaluation based on action identification, for example, diagnosis of spinal diseases and Parkinson's disease in which symptoms may be determined by body movements; scoring of sports events such as standard gymnastics and dance evaluated according to whether the actions meet a preset criterion, etc. The following description still uses an example in which the evaluation target is shoulder joint diseases. As an example, the first information 414 describes action evaluation information associated with shoulder joint diseases, such as related symptoms of shoulder joint diseases. Accordingly, the evaluation result of the object with respect to the evaluation target may be a determination result of whether the object suffers from shoulder joint diseases.

Continuing to refer to FIG. 4, in some embodiments, the action description text 412 generated by the first model 410 may be used as input of the second model 420. The second model 420 is an inference model different from the first model 410. For example, the second model 420 may be a language model.

The first model 410 is set as a multimodal model to facilitate receiving and understanding of different pieces of video content 402, thereby improving the accuracy of identification of the video content 402. The second model 420 is set as an inference model that focuses on comparison and analysis, thereby improving the accuracy of determination of the recognized action.

In some embodiments, the second model 420 generates the evaluation content of the object based on the first information and the action description text generated by the first model 410. The first information is generated by a third model 430. The third model 430 is a multimodal model different from the first model 410 and the second model 420. As an example, the third model 430 may be deployed in an external device that may communicate with the electronic device 110, and the external device sends the first information determined by the third model 430 to the second model 420.

In some embodiments, the third model 430 may receive a plurality of reference content items 432 associated with the evaluation target, generate criterion summary information based on the plurality of reference content items 432, and then the third model 430 may determine the first information 414 based on the criterion summary information. As an example, in the scenario of determination of shoulder joint diseases, the plurality of reference content items 432 associated with the evaluation target may be media content of shoulder joint disease diagnosis, such as diagnosis videos, science popularization videos, voices, etc. of shoulder joint diseases; or text content related to shoulder joint diseases, such as medical records, textbooks, papers, science popularization articles, etc. related to shoulder joint diseases. As an example, a plurality of science popularization videos of shoulder joint diseases mention that when a patient with shoulder joint diseases performs a back-touching action, that is, touches the contralateral scapula with one hand from above and touches the back with the other hand from below, if the two hands cannot touch each other, the shoulder joint has limited mobility. The corresponding criterion summary information may be action evaluation information of the back-touching action, that is, touching the contralateral scapula with one hand from above and touching the back with the other hand from below, and the two hands need to touch each other. In this way, the third model 430 may extract criterion summary information from actual diagnosis cases and disease-related professional materials, thereby improving the professionalism and accuracy of the first information.

In some embodiments, the electronic device 110 may perform a prompt engineering strategy on the first information and the second information, such as a chain of thought (COT) strategy and a self-consistency (SC) strategy. The COT strategy is an inference enhancement technology that guides the model to gradually generate an answer by explicitly decomposing a task into multiple logical steps. The SC strategy is a quality optimization technology that selects a result with the highest consistency or optimal coverage by performing generation multiple times for the same task. The combination of the two may form an efficient generation optimization technical framework and improve the accuracy of the generated evaluation result.

In some embodiments, the action evaluation information associated with the evaluation target may indicate execution criteria of a plurality of preset actions. As an example, the execution criteria may include an identification criterion, a trajectory criterion, a symmetry criterion, and the like. Taking abduction action as an example, the identification criterion may be that the arms are raised from both sides of the body, and the abduction action may be recognized according to the identification criterion. The trajectory criterion may be that the arms are stretched to 120° to 180°, and the completion of the abduction action may be judged according to the identification criterion. The symmetry criterion may be that the raising angles of the left and right arms are basically the same, for example, the difference between the raising angles is less than 10°, and the completion of the abduction action of the left and right arms may be respectively judged according to the symmetry criterion.

In some embodiments, the second model 420 may generate the evaluation content about the object based on the action description text and the action evaluation information associated with the evaluation target. For example, the action description text involves three actions of the object in total. The three actions are evaluated according to the first information, and the evaluation content of whether the object suffers from shoulder joint diseases may be obtained according to action evaluation results of the three actions on whether the three actions meet the action evaluation information.

In this way, in the embodiments of the present disclosure, two models, namely the first model 410 and the second model 420, are used to perform action understanding and result evaluation, respectively, thereby improving the robustness of the entire information processing solution and the accuracy of its output result.

In some embodiments, the electronic device 110 obtains the evaluation result of the object, that is, whether the object suffers from shoulder joint diseases, through the first model 410 and the second model 420. On this basis, the electronic device 110 may generate evaluation information associated with the evaluation result based on a comparison between the evaluation result of the object and a reference result. The reference result may be an actual diagnosis result of the object, which may be obtained by actual diagnosis by a doctor or obtained according to a medical record or medical diagnostic image of the object. The electronic device 110 compares the reference result with the evaluation result, and may obtain the evaluation information of the evaluation result, that is, whether the evaluation result is accurate. As an example, if the evaluation result of the object is the same as the reference result, the evaluation result is correct; otherwise, the evaluation result is wrong.

In some embodiments, the electronic device 110 may also obtain an overall evaluation accuracy according to the evaluation information of the evaluation results of a plurality of objects. For example, the electronic device 110 generates evaluation results of 100 objects in total, 90 of which are the same as their corresponding reference results, and the other 10 are different from their corresponding reference results, then the evaluation accuracy of the electronic device 110 is 90%.

In some embodiments, the evaluation information may not be determined only based on result accuracy. The evaluation information may also be determined according to specific diagnosis details, for example, the evaluation information may also include identification completeness associated with the action description text and evaluation rationality associated with the action evaluation information.

In some embodiments, the identification completeness of the electronic device 110 may be determined based on the number of actions recognized by the first model 410. The determination rule of identification completeness is shown in the following Table 1.

TABLE 1

| Label | | |
|---|---|---|
| classification | Label rules | Label definition |
| Identification | 1 = Complete | All actions of the object may be |
| completeness | identification | captured in the video |
| (A = 0, 0.5, | 0.5 = Partial | Only part of the actions of the |
| 1) | identification | object may be captured in the video |
| | 0 = Severe absence | All actions of the object are missed |

As an example, the object in the video content has completed four actions in total, namely action 1, action 2, action 3 and action 4. If the action description text describes that the object has completed four actions, namely action 1, action 2, action 3 and action 4, the first model 410 may capture all actions of the object in the video, and the identification completeness A is 1. If the action description text describes that the object has completed three actions, namely action 1, action 2 and action 4, the first model 410 misses one action and may only capture part of the actions of the object in the video, and the identification completeness A is 0.5. If the action description text describes that the object has completed 0 actions, the first model 410 misses all actions of the object, and the identification completeness A is 0.

In some embodiments, the identification completeness may reflect whether the first model 410 may completely recognize the actions done by the object. The electronic device 110 may perform feedback adjustment on the first model 410 according to the identification completeness, to improve the identification accuracy of the first model 410. As an example, if the first model 410 always misses a specific action, such as action 3, in a plurality of pieces of video content, the second information about action 3 may be adjusted.

In some embodiments, the evaluation rationality of the electronic device 110 may be determined based on an action determination result output by the second model 420. The determination rule of evaluation rationality is shown in the following Table 2.

TABLE 2

| Label | | |
|---|---|---|
| classification | Label rules | Label definition |
| Evaluation | 1 = Completely | The determination of each action is |
| rationality | rational | consistent with the action evaluation |
| (R = 0, 0.5, 1) | | information |
| | 0.5 = Partially | There are some misjudgments in the |
| | rational | determination of each action |
| | 0 = Completely | The determination of each action is |
| | irrational | contrary to the original video |
| | | content |

As an example, the object in the video content has completed four actions in total, namely action 1, action 2, action 3 and action 4, and the four actions all meet their corresponding action evaluation criteria. If the second model 420 considers that action 1, action 2, action 3 and action 4 all meet their corresponding action evaluation criteria, the determination of each action by the second model 420 is consistent with the action evaluation information, and the evaluation rationality R is 1. If the second model 420 considers that action 1, action 2 and action 4 all meet their corresponding action evaluation criteria, but action 3 does not meet its corresponding action evaluation information, the determination of action 3 by the second model 420 is a misjudgment, and the evaluation rationality R is 0.5. If the second model 420 considers that action 1, action 2, action 3 and action 4 all do not meet their corresponding action evaluation criteria, the determination of each action by the second model 420 is contrary to the original video content, and the evaluation rationality R is 0.

In some embodiments, the evaluation rationality may reflect whether the second model 420 may accurately determine whether each action meets the action evaluation information. The electronic device 110 may perform feedback adjustment on the second model 420 according to the evaluation rationality, to improve the evaluation accuracy of the second model 420. As an example, if the determination of a specific action, such as action 3, by the second model 420 is always wrong, the first information about action 3 may be adjusted.

In some embodiments, a specified action, such as a preset action, in the plurality of reference actions may be set as a key action. The above statistics on the number of actions and statistics on whether the action determination is correct may only be associated with the key action, so as to simplify the calculation and improve the efficiency.

In some embodiments, the result accuracy of the electronic device 110 may be determined based on the evaluation result of the object and the reference result. The determination rule of the result accuracy is shown in the following Table 3.

TABLE 3

| Label | | |
|---|---|---|
| classification | Label rules | Label definition |
| Result | 1 = Correct | The evaluation result is consistent |
| accuracy | diagnosis | with the reference result |
| (D = 0, 1) | 0 = Incorrect | The evaluation result is inconsistent |
| | diagnosis | with the reference result, or no |
| | | evaluation result is given |

As an example, the object in the video content suffers from shoulder joint diseases. If the evaluation result is that the object suffers from shoulder joint diseases, the evaluation result is consistent with the actual diagnosis result, and the result accuracy D is 1. If the evaluation result is that the object does not suffer from shoulder joint diseases, the evaluation result is inconsistent with the actual diagnosis result, and the result accuracy D is 0.

In some embodiments, when determining the availability of the entire process 200, the electronic device 110 may perform comprehensive determination in combination with the identification completeness A, the evaluation rationality R and the result accuracy D. As an example, the weights of the identification completeness A, the evaluation rationality R and the result accuracy D may be respectively set to 0.2, 0.3 and 0.5. Therefore, the calculation formula of the availability coefficient UI is: UI=0.5*D+0.3*R+0.2*A. The availability of the process 200 may be determined according to UI, for example, when UI is greater than a preset threshold, the performance of the current process 200 is good; when UI is less than the preset threshold, the performance of the current process 200 needs to be improved. It is worth mentioning that the identification completeness A, the evaluation rationality R and the result accuracy D and their corresponding weights are all illustrative descriptions, and in practical applications, the availability evaluation information may also be generated by combining more diagnosis details and different evaluation criteria.

It should be understood that the above specific values of the weight coefficients and the specific scoring rules are all intended as examples, without suggesting any limitation on the present disclosure.

In this way, in the embodiments of the present disclosure, two models are used to perform action understanding and result evaluation, respectively. First, in the embodiments of the present disclosure, a video is processed by the first model to obtain an action description text of an object in the video. Then, in the embodiments of the present disclosure, the action description text is analyzed by the second model to obtain evaluation content about the object. Compared with the traditional solution of directly analyzing a video using a model, in the solution proposed in the present disclosure, both models may be trained more professionally, thereby improving the robustness of the entire information processing solution and the accuracy of its output result. Furthermore, the second model analyzes the action description text in combination with the first information describing the action evaluation information associated with the evaluation target, so that the evaluation content output by the second model is more in line with the evaluation needs of users, thereby further improving the accuracy of the evaluation content about the object.

In some embodiments, a dataset associated with the evaluation target may also be used to fine-tune the first model, the second model and/or the third model. As an example, fine-tuning may be performed in manners such as low-rank adaptation (Low-Rank Adaptation of Large Language Model, LoRA) and supervised fine-tuning (Supervised Fine-Tuning, SFT), so that the first model, the second model and/or the third model are better matched with their corresponding analysis targets. In this way, the evaluation content generated through the above solution may be better aligned with the evaluation target, thereby improving the accuracy of the evaluation content about the object.

### Example Apparatus and Device

The embodiments of the present disclosure also provide a corresponding apparatus for implementing the above method or process. FIG. 5 shows a schematic structural block diagram of an example apparatus 500 for information processing according to some embodiments of the present disclosure. The apparatus 500 may be implemented as or included in the electronic device 110. Each module/component in the apparatus 500 may be implemented by hardware, software, firmware, or any combination thereof.

As shown in FIG. 5, the apparatus 500 includes: a first generation module 510 configured to provide video content associated with an object to a first model to generate an action description text of at least one action of the object; and a second generation module 520 configured to provide the action description text and first information to a second model to generate evaluation content about the object, the first information at least describing action evaluation information associated with an evaluation target, the evaluation content indicating an evaluation result of the object with respect to the evaluation target.

In some embodiments, the first information is generated based on the following process: providing a plurality of reference content items associated with the evaluation target to a third model, to obtain criterion summary information generated by the third model based on the plurality of reference content items; and determining the first information based on the criterion summary information.

In some embodiments, the plurality of reference content items include media content and/or text content associated with the evaluation target.

In some embodiments, the first generation module 510 is also configured to provide second information and the video content to the first model, to obtain the action description text generated by the first model based on the second information and the video content, the second information indicating an action identification criterion associated with a set of preset actions.

In some embodiments, the second information also indicates a set of capabilities associated with the first model, the set of capabilities including at least one of the following: a first capability for identifying an action of the object; a second capability for describing a trajectory of the corresponding action; a third capability for analyzing symmetry of the corresponding action; a fourth capability for analyzing compensation information of the corresponding action; and a fifth capability for analyzing fluency of the corresponding action.

In some embodiments, the second information is configured to instruct the first model to use relative position description to generate the action description text.

In some embodiments, the video content includes captured first video content; and/or uploaded second video content.

In some embodiments, the apparatus 500 also includes a third generation module, the third generation module being configured to generate evaluation information associated with the evaluation result based on at least a comparison between the evaluation result of the object and a reference result.

In some embodiments, the apparatus 500 also includes an adjustment module, the adjustment module being configured to adjust the first model and/or the second model with the evaluation information.

In some embodiments, the evaluation information is also determined based on at least one of the following: identification completeness associated with the action description text, the identification completeness being determined based on the number of actions recognized by the first model; or evaluation rationality associated with the action evaluation information, the evaluation rationality being determined based on an action determination result output by the second model.

In some embodiments, the evaluation content describes disease evaluation information associated with a preset disease, the preset disease being associated with an action representation of the object.

The units included in the apparatus 500 may be implemented in various ways, including software, hardware, firmware, or any combination thereof. In some embodiments, one or more units may be implemented using software and/or firmware, such as machine executable instructions stored on a storage medium. In addition to machine executable instructions or as an alternative, some or all units in the apparatus 500 may be implemented at least partially by one or more hardware logic components. As an example, rather than a limitation, example types of hardware logic components that may be used include field programmable gate array (FPGA), application specific integrated circuit (ASIC), application specific standard (ASSP), system on chip (SOC), complex programmable logic device (CPLD), and so on.

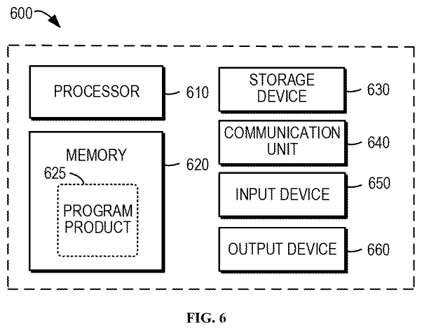

FIG. 6 shows a block diagram of an electronic device 600 in which one or more embodiments of the present disclosure may be implemented. It should be understood that the electronic device 600 shown in FIG. 6 is only illustrative, without suggesting any limitation on the function and scope of the embodiments described herein. The electronic device 600 shown in FIG. 6 may be used to implement the electronic device 110 in FIG. 1.

As shown in FIG. 6, the electronic device 600 is in the form of a general electronic device. The components of the electronic device 600 may include, but are not limited to, one or more processors or processing units 610, a memory 620, a storage device 630, one or more communication units 640, one or more input devices 650, and one or more output devices 660. The processing unit 610 may be an actual or virtual processor and may perform various processes based on the programs stored in the memory 620. In a multi-processor system, a plurality of processing units execute computer executable instructions in parallel to improve the parallel processing capability of the electronic device 600.

The electronic device 600 typically includes a plurality of computer storage medium. Such medium may be any available medium that is accessible to the electronic device 600, including, but not limited to, volatile and non-volatile medium, removable and non-removable medium. The memory 620 may be volatile memory (for example, a register, cache, a random access memory (RAM)), a non-volatile memory (such as a read-only memory (ROM), an electrically erasable programmable read-only memory (EEPROM), a flash memory), or any combination thereof. The storage device 630 may be any removable or non-removable medium, and may include a machine readable medium such as a flash drive, a disk, or any other medium, which may be used to store information and/or data and may be accessed within the electronic device 600.

The electronic device 600 may further include other removable/non-removable, volatile/non-volatile storage medium. Although not shown in FIG. 6, a disk driver for reading from or writing to a removable, non-volatile disk (such as a “floppy disk”), and an optical disk driver for reading from or writing to a removable, non-volatile optical disk may be provided. In these cases, each driver may be connected to the bus (not shown) by one or more data medium interfaces. The memory 620 may include a computer program product 625, which has one or more program modules configured to perform various methods or actions of the various embodiments of the present disclosure.

The communication unit 640 implements communication with other electronic devices through the communication medium. In addition, the functions of the components of the electronic device 600 may be implemented by a single computing cluster or a plurality of computing machines, which may communicate through communication connections. Therefore, the electronic device 600 may perform operations in a networked environment using a logical connection with one or more other servers, a network personal computer (PC) or another network node.

The input device 650 may be one or more input devices, such as a mouse, a keyboard, a tracking ball, etc. The output device 660 may be one or more output devices, such as a display, a speaker, a printer, etc. The electronic device 600 may also communicate with one or more external devices (not shown) through the communication unit 640 as needed, the external devices such as a storage device, a display device, etc., communicate with one or more devices that enable users to interact with the electronic device 600, or communicate with any devices (such as a network card, a modem, etc.) that enable the electronic device 600 to communicate with one or more other electronic devices. Such communication may be performed via input/output (I/O) interfaces (not shown).

According to an example implementation of the present disclosure, there is provided a computer-readable storage medium having computer executable instructions stored thereon, where the computer executable instructions are executed by a processor to implement the method described above. According to an example implementation of the present disclosure, there is further provided a computer program product tangibly stored on a non-transitory computer-readable medium and including computer executable instructions, and the computer executable instructions are executed by a processor to implement the method described above.

Various aspects of the present disclosure are described herein with reference to the flowcharts and/or block diagrams of the method, apparatus, device and computer program product implemented according to the present disclosure. It should be understood that each block of the flowcharts and/or block diagrams, and combinations of blocks in the flowcharts and/or block diagrams may be implemented by computer-readable program instructions.

These computer-readable program instructions may be provided to a processing unit of a general-purpose computer, a special-purpose computer, or other programmable data processing apparatus, so that a machine is produced, such that when these instructions are executed by the processing unit of the computer or other programmable data processing apparatus, an apparatus for implementing the functions/actions specified in one or more blocks of the flowcharts and/or block diagrams is generated. These computer-readable program instructions may also be stored in a computer-readable storage medium, and these instructions cause the computer, the programmable data processing apparatus, and/or other devices to work in a specific manner, so that the computer-readable medium storing the instructions includes a manufactured product, which includes instructions for implementing various aspects of the functions/actions specified in one or more blocks of the flowcharts and/or block diagrams.

The computer-readable program instructions may be loaded onto a computer, other programmable data processing apparatus, or other devices, so that a series of operation steps are performed on the computer, other programmable data processing apparatus, or other devices to generate a computer-implemented process, thereby enabling the instructions executed on the computer, other programmable data processing apparatus, or other devices to implement the functions/actions specified in one or more blocks of the flowcharts and/or block diagrams.

The flowcharts and block diagrams in the drawings show the possibly implemented architectures, functions and operations of the system, method and computer program product according to a plurality of implementations of the present disclosure. In this regard, each block in the flowchart or block diagram may represent a module, program segment or part of instruction, and the module, program segment or part of instruction contains one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagrams and/or flowcharts, and the combinations of the blocks in the block diagrams and/or flowcharts may be implemented by a dedicated hardware-based system that performs specified functions or actions, or by a combination of dedicated hardware and computer instructions.

The implementations of the present disclosure have been described above, and the above description is illustrative, not exhaustive, and is not limited to the disclosed implementations. Without departing from the scope of the illustrated implementations, many modifications and changes will be apparent to those of ordinary skill in the art. The terms used herein are selected to best explain the principles of the implementations, the practical applications or improvements to the technologies in the market, or to enable other ordinary skilled persons in the art to understand the implementations disclosed herein.

1. A method of information processing, comprising:
providing video content associated with an object to a first model to generate an action description text of at least one action of the object; and
providing the action description text and first information to a second model to generate evaluation content about the object, the first information at least describing action evaluation information associated with an evaluation target, the evaluation content indicating an evaluation result of the object with respect to the evaluation target.

2. The method of claim 1, wherein the first information is generated based on a process comprising:
providing a plurality of reference content items associated with the evaluation target to a third model, to obtain criterion summary information generated by the third model based on the plurality of reference content items; and
determining the first information based on the criterion summary information.

3. The method of claim 2, wherein the plurality of reference content items comprise media content and/or text content associated with the evaluation target.

4. The method of claim 1, wherein generating the action description text of the at least one action of the object comprises:
providing second information and the video content to the first model, to obtain the action description text generated by the first model based on the second information and the video content, the second information indicating an action identification information associated with a set of predetermined actions.

5. The method of claim 4, wherein the second information further indicates a set of capabilities associated with the first model, the set of capabilities comprising at least one of:
a first capability for identifying an action of the object,
a second capability for describing a trajectory of the corresponding action,
a third capability for analyzing symmetry of the corresponding action,
a fourth capability for analyzing compensation information of the corresponding action, or
a fifth capability for analyzing fluency of the corresponding action.

6. The method of claim 4, wherein the second information is configured to instruct the first model to use relative position description to generate the action description text.

7. The method of claim 1, wherein the video content comprises:
captured first video content, and/or
uploaded second video content.

8. The method of claim 1, further comprising:
generating evaluation information associated with the evaluation result based on at least a comparison between the evaluation result of the object and a reference result.

9. The method of claim 8, further comprising:
adjusting the first model and/or the second model with the evaluation information.

10. The method of claim 8, wherein the evaluation information is determined further based on at least one of:
identification completeness associated with the action description text, the identification completeness being determined based on a number of actions identified by the first model, or
evaluation rationality associated with the action evaluation information, the evaluation rationality being determined based on an action determination result output by the second model.

11. The method of claim 1, wherein the evaluation content describes disease evaluation information associated with a predetermined disease, the predetermined disease being associated with an action representation of the object.

12. An electronic device, comprising:
at least one processor; and
at least one memory, the at least one memory being coupled to the at least one processor and storing instructions for execution by the at least one processor, the instructions, when executed by the at least one processor, causing the electronic device to perform acts comprising:
providing video content associated with an object to a first model to generate an action description text of at least one action of the object; and
providing the action description text and first information to a second model to generate evaluation content about the object, the first information at least describing action evaluation information associated with an evaluation target, the evaluation content indicating an evaluation result of the object with respect to the evaluation target.

13. The electronic device of claim 12, wherein the first information is generated based on a process comprising:
providing a plurality of reference content items associated with the evaluation target to a third model, to obtain criterion summary information generated by the third model based on the plurality of reference content items; and
determining the first information based on the criterion summary information.

14. The electronic device of claim 13, wherein the plurality of reference content items comprise media content and/or text content associated with the evaluation target.

15. The electronic device of claim 12, wherein generating the action description text of the at least one action of the object comprises:
providing second information and the video content to the first model, to obtain the action description text generated by the first model based on the second information and the video content, the second information indicating an action identification information associated with a set of predetermined actions.

16. The electronic device of claim 15, wherein the second information further indicates a set of capabilities associated with the first model, the set of capabilities comprising at least one of:
a first capability for identifying an action of the object,
a second capability for describing a trajectory of the corresponding action,
a third capability for analyzing symmetry of the corresponding action,
a fourth capability for analyzing compensation information of the corresponding action, or
a fifth capability for analyzing fluency of the corresponding action.

17. The electronic device of claim 15, wherein the second information is configured to instruct the first model to use relative position description to generate the action description text.

18. The electronic device of claim 12, wherein the video content comprises:
captured first video content, and/or
uploaded second video content.

19. The electronic device of claim 12, wherein the acts further comprise:
generating evaluation information associated with the evaluation result based on at least a comparison between the evaluation result of the object and a reference result.

20. A non-transitory computer-readable storage medium having a computer program stored thereon, the computer program being executable by a processor to implement acts comprising:
providing video content associated with an object to a first model to generate an action description text of at least one action of the object; and
providing the action description text and first information to a second model to generate evaluation content about the object, the first information at least describing action evaluation information associated with an evaluation target, the evaluation content indicating an evaluation result of the object with respect to the evaluation target.
